(19) United States
(12) Patent Application Publication
(10) Pub. No.: US 2026/0217113 A1
(43) Pub. Date: Jul. 30, 2026

(54) Display Device and Motor Vehicle Having a Display Device

(71) Applicant: Bayerische Motoren Werke Aktiengesellschaft, Muenchen (DE)

(72) Inventors: Harald LATHWESEN, Mauern (DE); Peter SCHNEIDER, Haar (DE)

(21) Appl. No.: 19/146,036

(22) PCT Filed: Feb. 21, 2024
(86) PCT No.: PCT/DE2024/100139

§ 371 Date: Jul. 7, 2025

(30) Foreign Application Priority Data
Mar. 7, 2023 (DE) 10 2023 105 610.7

(51) Int. Cl. B60K 35/231; B60K 35/22; B60K 35/235; B60K 35/53; G02B 27/00; G02B 27/01

(52) U.S. Cl. CPC B60K 35/231; B60K 35/22; B60K 35/235; B60K 35/53; G02B 27/0093; G02B 27/0101; G02B 27/0149; B60K 2360/66; B60K 2360/771; G02B 2027/0154

(57) ABSTRACT

A display device includes a screen unit. The screen unit has a first side arranged and/or supported on an inner side of a vehicle roof and a second side opposite the first side. The second side has a screen for displaying an image. The display device includes a reflector unit for reflecting and projecting an image displayed by the screen. A movement unit translationally moves the reflection unit relative to the screen unit.

### BACKGROUND AND SUMMARY

The present disclosure relates to a display apparatus for arrangement on a roof inner side of a motor vehicle and/or a motor vehicle which comprises the display apparatus.

It is known in a motor vehicle, for example, a passenger vehicle, to mount a display device for visually displaying an image and/or video in a state associated with a seat on the inner side of the vehicle roof.

Known display devices are associated with an observer who is located in a rear seat row and accordingly fitted at that location. Although adjustment mechanisms are sometimes proposed in order to adapt a viewing distance, they do not enable sufficiently flexible handling taking into account other interior components of the vehicle. The structural space available overall for the arrangement of the display device is also often only inadequately used.

Document DE 10 2016 225 745 A1 describes a screen which is arranged and secured in a vehicle interior in the region of a vehicle roof inner side, wherein the screen extends continuously over at least a half of the width, preferably at least two-thirds of the width, in particular substantially the entire width, of the vehicle roof inner side.

Document DE 10 2019 131 925 A1 describes a display device for the interior of a vehicle. A display unit is configured to visually display information, has a display element for this purpose, and can be or is arranged in a longitudinal extent direction of the vehicle behind a front seat row, preferably on a roof liner of the vehicle. A movement unit is configured to move the display unit, in particular with the display element pivoted away from the roof liner of the vehicle, in the longitudinal extent direction, in particular in a controllable manner, between different positions for use and/or to retain it in a specific position for use. A control unit is configured to control the movement unit in such a manner that the display unit and the display element are arranged or become arranged with a predetermined first distance or first distance range with respect to an element of the front seat row.

Document DE 10 2020 101 719 A1 describes a display device for the interior of a vehicle. A display unit is configured to visually display information and can be or is arranged on a roof liner of the vehicle. A movement unit is configured to move the display unit in a longitudinal extent direction of the vehicle in a controllable and/or adjustable manner between different positions for use and/or to retain it in a given position for use. In this instance, a first position for use has a first position for or in a front seat row in the longitudinal extent direction and a second position for use in a rear seat row in the longitudinal extent direction or for or in a luggage compartment for the display unit.

Display devices which in each case comprise a screen and a mirror screen which together produce a virtual image in space are further known. It is thereby possible for sufficient observation spacing to be produced between a user and the virtual image. To this end, such a display device must be arranged as far as possible in front of the user in the vehicle. In the case of an arrangement in the rear of a vehicle, the front seats delimit the structural space in a forward direction since the mirror screen must maintain sufficient spacing with respect to the front seats. It is therefore advisable to make the display system adjustable and to keep the spacing with respect to the respective seat adjustment at the front as small as possible.

Until now, it has only been known to store such a display device in a rail system and for the complete display device to follow the front seats. If the front seats are adjusted forward or backward by an amount X, the complete display device is thus also adjusted by the same amount X, whereby the virtual image is spatially displaced by the amount X.

For example, a viewing distance between the eye of the passenger and the virtual image with respect to conventional display devices, which substantially comprise only one screen, can already be increased by, for example, more than 150 mm. This makes the viewing of screen contents significantly more pleasant.

Such a display device must be orientated toward the largest front passenger or a front seat which is pushed a long way back. With smaller front passengers who accordingly push the front seat further forward, the entire display system can also be pushed forward.

It is disadvantageous in this instance that the entire display apparatus in the motor vehicle has to be displaced. This also includes the screen(s) which has/have to be supplied with power or data by means of electrical lines. In addition, known display apparatuses are relatively heavy (generally several kg) and therefore require a complex mechanism for displacement.

Furthermore, this type of determination cannot provide the maximum possible viewing distance. Instead, with each millimeter by which the display apparatus is pushed forward, barely one millimeter in additional viewing distance is gained.

Against the background of this prior art, an object of the present disclosure is to provide an apparatus which in each case is suitable for enriching the prior art.

The object is achieved with the features described herein.

Accordingly, the object is achieved at least by a display apparatus for arrangement on a roof inner side of a motor vehicle, as described herein. The display apparatus may, for example, also be referred to as a combiner display apparatus (or system).

The display apparatus comprises a screen device which comprises a first side for arrangement on and/or abutment against the roof inner side (and/or a roof liner of the motor vehicle) and a second side which is opposite the first side and which has a screen for displaying an image.

The display apparatus comprises a reflector device for reflection and projection of an image displayed by the screen. The reflector device may also be referred to as a mirror screen and/or combiner screen.

The display apparatus comprises a movement device for translational movement of the reflector device relative to the screen device. The movement device may also be referred to as an adjustment mechanism of the reflector device.

The reflector device may be configured (and/or arranged) in order in a situation for use (and, for example, in the installed state) to make the image displayed by the screen visible for a user, for example, a vehicle passenger. The user may be located, for example, be sitting behind the reflector device and/or at a side of the screen device opposite the reflector device. The reflector device may be located in a situation for use in a field of vision and/or viewing direction of the user who is, for example, looking at the reflector device.

As a result of the reflection and projection of an image displayed by the screen, a virtual image can be produced (or displayed). The image displayed by the screen may be able to be reflected by the reflector device to eyes of a user in order to produce a virtual image which is located for the user behind the reflector device.

The virtual image may be produced by means of a position of the screen device and the reflector device with respect to each other and an eye position of a user. A surface of the reflector device may, for example, be arranged at an angle of 45 degrees+/−20 degrees, optionally+/−10 degrees with respect to the first side of the screen device.

A (viewing) distance of the user from the virtual image can be produced from a distance of the user from the reflector device and a distance of the reflector device from the screen device. In other words, with increasing distance of the reflector device from the screen device, the virtual image for the user can be increasingly displayed behind the reflector device.

The display apparatus may further have a carrier on which the screen device and the movement device are mounted.

The reflector device may be able to be moved by means of the movement device manually or in an automated manner, for example, mechanically, electrically, hydraulically and/or electrohydraulically. The movement device may have, for example, at least one guide rail which can be or is fitted to the roof inner side and extends, for example, in the width direction of the screen device and/or in the longitudinal direction of the motor vehicle, at least one pivot arm and/or at least one telescopic arm.

The display apparatus described above affords a series of advantages. Inter alia, it is advantageously not necessary for the screen itself to be arranged so as to be movable itself with the electrical connections thereof and the electronic system which is integrated therein. The movable component, that is to say the reflector device by means of the movement device can be configured to be lighter and consequently a kinematic system for moving the movable component of the display apparatus may also be configured for a lower weight. The reflector device may, for example, weigh 400 g. In a situation installed in a motor vehicle, the lower weight of the reflector device also has in comparison with a screen advantages in the case of a front-end collision in which it is possible that a person sitting behind the reflector device may strike the reflector device since the reflector device has a lower weight.

Furthermore, with the displacement only of the reflector device a viewing distance which is increased by (almost) double the displacement path (or adjustment path) can advantageously be obtained. In an installation situation in which the display apparatus is arranged behind a front seat and the space for displacement (or for translational movement) of the reflector device in a forward direction is limited by this front seat, the viewing distance when the reflector device follows, when the front seat is, for example, displaced forward, is increased by (almost) twice the displacement path (or adjustment path) since the viewing distance which is obtained is composed of the distance of the eye of a user from the reflector device which can be increased approximately by the front seat which has been pushed forward, and the distance of the virtual image behind the reflector device which increases in accordance with the increased distance between the screen and the reflector device which has been displaced forward.

Possible further developments of the above-described display apparatus will be explained in detail below.

The screen device may be configured for fixed and/or non-movable arrangement on or in the roof inner side (and/or the roof liner of the motor vehicle).

The movement device may be configured to move the reflector device parallel or obliquely downward and/or upward with respect to a longitudinal direction of the motor vehicle between different positions for use. The movement device may be configured to move the reflector device parallel or obliquely downward and/or upward with respect to a longitudinal direction of the motor vehicle between different positions for use.

The movement device may further be configured for rotational movement of the reflector device relative to the screen device. The rotational movement may comprise pivoting about a pivot axis which is orientated parallel in a state offset with respect to the second side of the screen device.

The movement device may be configured for rotational movement of the reflector device in order to pivot the reflector device between a position for non-use, in which the reflector device is orientated parallel with the second side and/or the screen, and/or the reflector device conceals the screen and a plurality of positions for use. In one of the plurality of positions for use, the reflector device and the screen device may define an angle less than 180°, optionally less than or equal to 90°.

The rotational movement may be coupled to the translational movement. The movement device may further be configured to automatically carry out the rotational movement in accordance with the translational movement.

The movement device may further be configured for tilting movement of the reflector device about a tilting axis perpendicularly to the pivot axis.

The display apparatus may be configured to correct a tilting of an image which is reflected and projected by the reflector device by means of a tilting movement of the reflector device using the movement device and/or by rotating the image displayed by the screen.

The display apparatus may further comprise a detection device.

The detection device may be configured to detect an eye position (and/or viewing direction) of a user who is located in a situation for use of the display apparatus behind the display apparatus (for example, in the forward travel direction of the motor vehicle).

The detection device may be configured to detect a distance between the reflector device and an object which is arranged in the situation for use in front of the display apparatus (for example, in the forward travel direction of the motor vehicle). The object may be an element (for example, a headrest) of a front row of seats (or at least one front seat), a driver's seat and/or a passenger seat of the motor vehicle.

The display apparatus may further comprise a control apparatus which is connected in technical signal terms to the detection device and which is configured to control (or control and/or regulate) the movement device in order to move the reflector device depending on the detected eye position of the user and/or the detected distance.

The control apparatus may be configured to control the movement device for moving the reflector device taking into account the detected distance in such a manner that the reflector device is arranged with minimal spacing with respect to the object.

The control apparatus may be configured to check the distance between the reflector device and the object repeatedly and/or continuously and to follow it in order to maintain a minimum distance.

The minimum distance may, for example, be a distance which ensures that even with a changing load in the front seat row, for example, when a front vehicle passenger moves and/or as a result of the resilience of a front seat, no contact between an element of the front seat row, for example, a headrest, and the reflector device can occur.

The control apparatus may be configured to control the movement device in order to move the reflector device taking into account the detected eye position in such a manner that the reflector device is arranged with a minimum eye distance from the user.

The control apparatus may be configured to check the eye position repeatedly and/or continuously and to follow it in order to maintain a minimum eye distance.

The detection device may have at least one sensor unit in order to detect the eye position and/or the distance.

The reflector device may be formed from an inherently rigid plate. The reflector device can be made from plastics material, for example, from Plexiglass or a fiber-reinforced plastics material, or from glass. Advantageously, the reflector device can be adequately rigid with respect to an image to be reflected in order to avoid distortion of the image to be reflected. Alternatively or additionally, the reflector device may have a reinforcement frame.

The reflector device may have a reflective layer which may be polarized in accordance with an emitted light of the screen device. The reflective layer may be adapted to properties of the screen device, for example, the light emitted from the screen device may be p-polarized or polarized with an additionally applied polarizer. Advantageously, the reflector device may be configured in such a manner that only the polarized light of the screen device, but not other components inside the motor vehicle or other objects are reflected.

The reflector device may be configured to be transparent or partially transparent. Advantageously, a transparency of the reflector device enables an uninterrupted forward view for the user sitting in front.

An outer form of the reflector device may be adapted to the virtual image. The reflector device cannot be configured in a square or rectangular manner.

What has been described above can be summarized in other words and with a possible more specific embodiment of the disclosure as described below, wherein the following description is intended to be understood to be non-limiting for the disclosure.

In the context of the present disclosure, the display(s) (or screens of the screen device) may be mounted in a fixed manner in the vehicle and only the mirror screen (or the reflector device) can appropriately follow the front seats. A leverage factor in favor of the viewing distance may thereby be possible. Theoretically, the increase of the viewing distance may increase by twice the amount that the seats have been moved forward. The system may thus be configured for the largest seat percentile which is intended to be taken into account in the first seat row. This may determine the rearmost adjustment position of the mirror screen which in turn can determine the position of the display(s). If the front seats move forward, only the mirror screen can follow.

For example, the mirror screen may, for example, be displaced in a translational manner in a guide. Since in this instance the beam path changes slightly, the viewer can adapt the angular setting of the mirror screen accordingly. This can be carried out manually. It is conceivable to couple this necessary rotation to the translational movement and automatically to follow it. This can also be electrified if desired. It is also possible via a sensor to detect the eye position of the viewer (or the user) and automatically to produce the optimum position of the mirror screen in the motor vehicle, also depending on the position of the front seats. To this end, a coordinate exchange between the front seats and the display system may take place, as disclosed, for example, in document DE 10 2019 131 925 A1.

In other words: the display may in a securely installed state always remain at the same position in the roof. Only the combiner screen (or mirror screen and/or reflector device) which, for example, weighs only approximately 400 g, can be displaced so that a simpler kinematics is sufficient.

If a plurality of display apparatuses are arranged, each of the combiner screens may be adapted separately to the position of the front seat. If the entire system were to be displaced, the seat located furthest to the rear would always have to be taken as the reference.

With the displacement of the combiner screen, an (almost) twice as large increase of the viewing distance can be obtained since the viewing distance which is obtained is composed of the following two components: the distance of the eye from the combiner screen which is increased approximately by the front seat which is pushed forward, and the distance of the virtual image behind the combiner screen which increases in accordance with the increased distance between the display and the combiner screen which has been moved forward.

Furthermore, the virtual image may tilt with changed distances and with different eye positions in the rear with respect to the orthogonal of the viewing beam. This may, for example, be taken up by the right and left side of the combiner screen moving forward by different distances or the image on the screen being slightly rotated so that it is straight again in the virtual image.

Furthermore, a motor vehicle which comprises the above-described display apparatus is provided.

The motor vehicle may be a passenger vehicle, in particular a car, or a utility vehicle, such as, for example, a truck.

The motor vehicle may comprise a front seat row (or at least one front seat), a driver's seat and/or a passenger seat. The front seat row, the driver's seat and/or the passenger seat may be longitudinally adjustable.

The motor vehicle may comprise a rear seat row. The display apparatus may be associated with the rear seat row and/or the reflector device may be configured (and/or arranged) in order in a situation for use to make the image displayed by the screen visible for a vehicle passenger located, for example, sitting in the rear seat row.

The display apparatus may be arranged on a roof inner side in a rear of the motor vehicle.

The display apparatus may be arranged in a longitudinal direction and/or forward travel direction of the motor vehicle behind a front seat row, a driver's seat and/or a passenger seat.

The movement device can be configured for translational movement of the reflector device, to move the reflector device forward in the longitudinal direction and/or in the forward travel direction of the motor vehicle away from the screen device and backward in the longitudinal direction and/or in the rear travel direction of the motor vehicle in the direction toward the screen device.

Outer edges of the screen device may extend parallel or perpendicularly with respect to the longitudinal direction (and/or transverse direction) of the motor vehicle. The first side and/or second side of the screen device may extend parallel with the roof inner side.

A longitudinal direction of the screen device and/or reflector device may extend in the transverse direction of the motor vehicle. A length of the screen device and/or reflector device may correspond to at least a half of a width of the motor vehicle.

It is also conceivable for the motor vehicle to comprise a plurality of the above-described display apparatuses, for example, a first display apparatus and a second display apparatus. The first display apparatus may be arranged behind the driver's seat and the second display apparatus may be arranged behind the passenger seat. The first display apparatus and a second display apparatus may be arranged beside each other, for example, parallel or at an angle with respect to each other.

What has been described above in relation to the display apparatus also applies to the motor vehicle and vice versa.

Exemplary embodiments will now be described with reference to the Figures.

### BRIEF DESCRIPTION OF DRAWINGS

FIGS. 1A, 1B schematically show a known motor vehicle having a display apparatus, and

FIG. 2 schematically shows a motor vehicle according to the disclosure having a display apparatus.

### DETAILED DESCRIPTION OF DRAWINGS

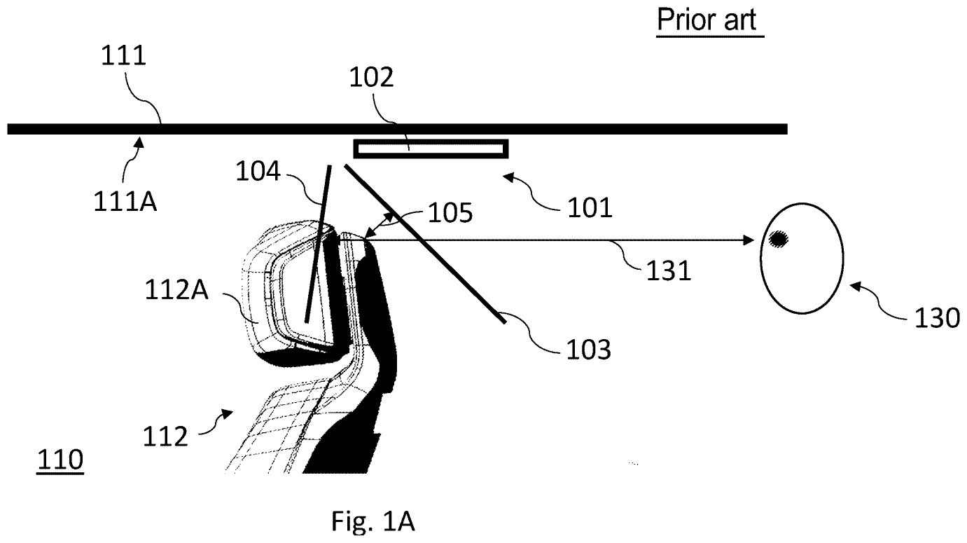

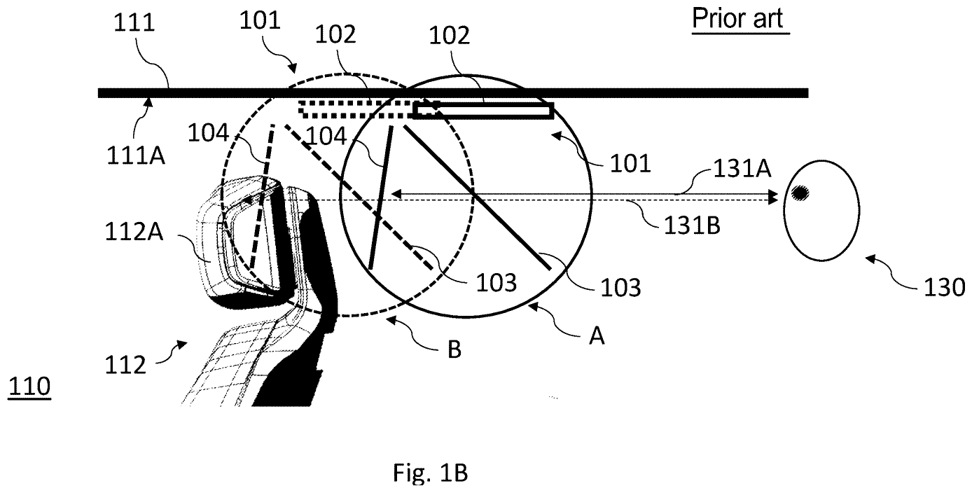

In FIG. 1A, the known vehicle 110 according to the prior art is illustrated purely schematically.

The motor vehicle 110 comprises the display apparatus 101 which is mounted on a carrier on a roof inner side 111A of the roof 111.

The display apparatus 101 comprises a screen device 102 which is orientated parallel with the roof inner side 111A, and a pivotably fitted reflector device 103 for reflection and projection of an image displayed by a screen of the screen device 102. In order to simplify the view, only one plane of the reflector device 103 is illustrated, wherein the reflector device in the embodiment is secured to the screen device 102 or to the carrier of the display apparatus 101.

The display apparatus 101 is arranged behind a front seat row which comprises the front seat 112. A user 103 looking at the reflector device 103 in a situation for use of the display apparatus 101 is located in a rear seat row and is sitting, for example, on a rear seat.

The reflector device 103 is configured or arranged to make the image displayed by the screen visible for the user 130 in the situation for use. As a result of the reflection and projection of an image displayed by the screen of the screen device 102, a virtual image 104 is produced (or displayed), wherein the image is reflected via the reflector device 103 to eyes of the user 130 in order to produce the virtual image 104 which is located for the user 130 behind the reflector device 103.

A viewing distance 131 between the user 131 and the virtual image 104 is produced from a distance of the user 131 from the reflector device 103 and a distance of the reflector device 103 from the screen device 102. In other words, as the distance of the reflector device 103 from the screen device 102 increases, the virtual image 104 for the user 130 can be displayed increasingly behind the reflector device 103.

When the reflector device 103 is pivoted, as a result of the flexibility of the front seat 112, for example, the longitudinal adjustability thereof, a minimum distance 105 between a headrest 112A of the front seat 112 and the reflector device 103 is intended to be maintained. Since the front seat 112 is longitudinally adjustable in the motor vehicle 110, it is advantageous to also make the display apparatus adjustable in order at all times to provide the maximum possible viewing distance for the users 131.

To this end, it is known that the entire display apparatus 101 can be displaced in the longitudinal direction of the motor vehicle 111. To this end, the entire display apparatus 101 may be guided, for example, in at least one guide rail.

FIG. 1B shows schematically the known vehicle 110 with the display apparatus 101 in two different adjustment positions A and B. In this instance, the display apparatus 101 is illustrated for each of the adjustment positions and highlighted with a circle, wherein the display apparatus 101 and the circle are illustrated in the adjustment position A with solid lines and in the adjustment position B with broken lines.

If the front seat 112 is adjusted forward, for example, by an adjustment path X, the display apparatus 101 can be adjusted to the same extent, that is to say the same adjustment path X, from the adjustment position A forward into the adjustment position B. From this displacement, the viewing distance 131A increases by the adjustment path X so that the viewing distance 131B is produced. If the front seat 112 is, for example, adjusted forward by 50 mm, the viewing distance also increases by 50 mm.

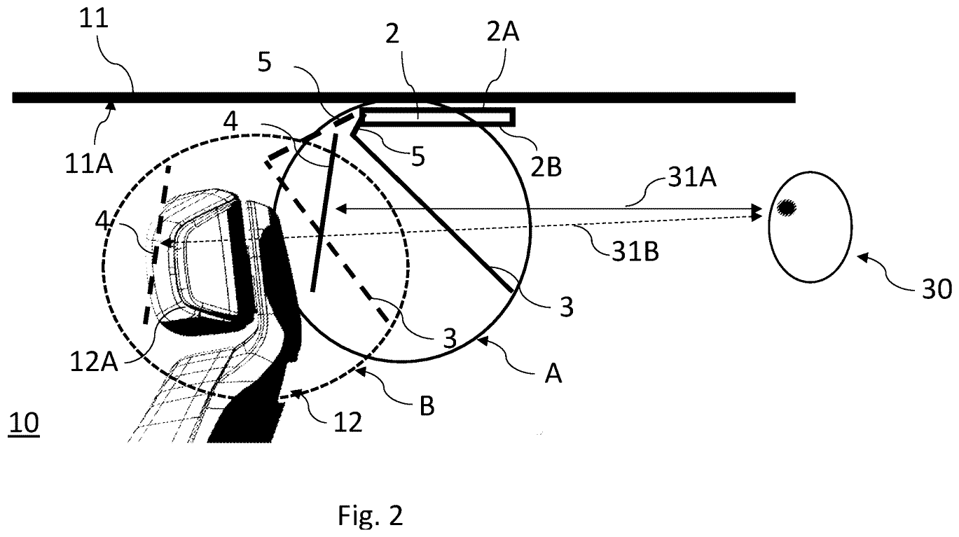

In FIG. 2, the vehicle 10 according to one embodiment of the present disclosure is illustrated purely schematically.

The motor vehicle 10 comprises the display apparatus 1 which is arranged on a roof inner side 11A of the roof 11, for example, in a rear of the motor vehicle 10.

The display apparatus 1 comprises a screen device 2 which comprises a first side 2A for arrangement on and/or abutment against the roof inner side 11A and a second side 2B which is opposite the first side 2A and has a screen for displaying an image. In contrast to the screen device 102 of the known display apparatus 101, the screen device 2 is securely and/or immovably arranged (or mounted) on or in the roof inner side 11A.

The display apparatus 1 further comprises a reflector device 3 for reflection and projection of an image displayed by the screen, and a movement device 5 for translational movement of the reflector deice 3 relative to the screen device 2.

The display apparatus 1 is arranged behind a front seat row which comprises the front seat 12. A user 30 looking at the reflector device 3 in a situation for use of the display apparatus 1 is located in a rear seat row and is sitting, for example, on a rear seat.

In a similar manner to the known display apparatus 101 with the reflector device 103, the reflector device 3 is configured or arranged to make the image displayed by the screen visible for the user 30 in the situation for use, wherein a virtual image 4 is produced (or displayed).

In order for the display apparatus 1 to be able to follow the longitudinally adjustable front seat 1 and consequently at all times to be able to provide the maximum possible viewing distance for the users 30, it is possible to move the reflector device 3 by means of the movement device 5 independently of the screen device 2, for example, toward or away from a front seat 12. In this instance, a minimum spacing between the reflector device 32 and a headrest 12A of the reflector device 3 should be maintained.

Two different adjustment positions A and B of the reflector device 3 and the movement device 5 are shown. In this instance, the reflector device 3 and the movement device 5 are illustrated for each of the adjustment positions and highlighted by a circle, wherein the reflector device 3, the movement device 5 and the circle are illustrated in the adjustment position A with solid lines and in the adjustment position B with broken lines.

If the front seat 12 is adjusted forward, for example, by an adjustment path X, the reflector device 3 can be adjusted by the same extent, that is to say, the same adjustment path X, from the adjustment position A forward into the adjustment position B. From this displacement, the viewing distance 31A is increased by (almost) double the adjustment path X so that the viewing distance 31B is produced. If the front seat 12 is adjusted forward, for example, by 50 mm, the viewing distance increases by a factor of 2, that is to say by approximately 100 mm.

In the schematic illustration, in addition to the other components, the movement device 5 is also illustrated schematically and in a very simplified manner. The movement device 5 may be secured to the screen device 2 and/or a carrier of the display apparatus 1. Furthermore, the movement device 5, for example, at least one guide rail which is fitted to the roof inner side 11A and which extends in the longitudinal direction of the motor vehicle 10, may have at least one pivot arm and/or at least one telescopic arm.

Furthermore, the movement device 5 may be configured to move the reflector device 3 not only in the longitudinal direction of the motor vehicle 10 between different positions for use, but instead, for example, obliquely in a downward direction and/or upward direction to a width direction of the screen device 2 or the longitudinal direction of the motor vehicle 10. A displacement of the reflector device in a (vehicle) height is non-critical.

The movement device 5 may further be configured for rotational movement of the reflector device 3 relative to the screen device 2, wherein the rotational movement may involve pivoting about a pivot axis which is orientated parallel in a state offset with respect to the second side 2B of the screen device 2.

The rotational movement may be coupled to the translational movement and/or the movement device 5 may further be configured to automatically carry out the rotational movement depending on the translational movement.

The movement device 5 may further be configured for tilting movement of the reflector device 3 about a tilting axis perpendicular to the pivot axis. If the reflector device 3 can be tilted, the display apparatus 1 may, for example, further be configured to correct a tilting of an image reflected and projected by the reflector device 3, that is to say the virtual image 4, that is to say by means of a tilting movement of the reflector device 3 using the movement device 5 and/or by rotating the image displayed by the screen.

The display apparatus 1 may further comprise a detection device and a control apparatus. The detection device may be configured to detect an eye position of a user who in a situation for use of the display apparatus 1 is located behind the display apparatus 1 and/or a distance between the reflector device 3 and an object which in the situation for use is arranged in front of the display apparatus 1. The control apparatus may be connected in technical signal terms to the detection device and configured to control the movement device 5 in order to move the reflector device 3 depending on the detected eye position of the user and/or the detected distance, for example, in order to maintain a minimum distance between the reflector device 3 and the headrest 12A.

### LIST OF REFERENCE NUMERALS

1 Display apparatus
2 Screen device
2A First side of the screen device
2B Second side of the screen device
3 Reflector device
4 Virtual image
5 Movement device
A, B Adjustment positions of the display apparatus
10 Motor vehicle
11 Roof
11A Roof inner side
12 Front seat
12A Headrest of the front seat
30 User
31A, 31B Viewing distance
101 Display apparatus (according to the prior art)
102 Screen device (according to the prior art)
103 Reflector device (according to the prior art)
104 Virtual image (according to the prior art)
105 Minimum distance between headrest and reflector device (according to the prior art)
A, B Adjustment positions of the display apparatus (according to the prior art)
110 Motor vehicle (according to the prior art)
111 Roof (according to the prior art)
111A Roof inner side (according to the prior art)
112 Front seat (according to the prior art)
112A Headrest of the front seat (according to the prior art)
130 User (according to the prior art)
131 Viewing distance (according to the prior art)
131A, 131B Viewing distance (according to the prior art)

1-10. (canceled)

11. A display apparatus for arrangement on a roof inner side of a motor vehicle, comprising:
a screen device, wherein the screen device includes: a first side configured to be arranged on and/or to abut against the roof inner side, and a second side opposite the first side, wherein the second side has a screen that displays an image;
a reflector device that reflects and projects the image displayed by the screen; and
a movement device that translationally moves the reflector device relative to the screen device.

12. The display apparatus of claim 11, wherein the screen device is configured for fixed and/or non-movable arrangement on or in the roof inner side.

13. The display apparatus of claim 11, wherein the movement device is configured to move the reflector device parallel or obliquely downward and/or upward with respect to a width direction of the screen device and/or a longitudinal direction of the motor vehicle between different positions for use.

14. The display apparatus of claim 11, wherein the movement device is configured for rotational movement of the reflector device relative to the screen device, and wherein the rotational movement comprises pivoting about a pivot axis which is orientated parallel in a state offset with respect to the second side of the screen device.

15. The display apparatus of claim 14, wherein the rotational movement is coupled to the translational movement and/or the movement device is configured to automatically carry out the rotational movement in accordance with the translational movement.

16. The display apparatus of claim 14, wherein the movement device is configured for tilting movement of the reflector device about a tilting axis perpendicularly to the pivot axis.

17. The display apparatus of claim 16, wherein the display apparatus is configured to correct a tilting of an image reflected and projected by the reflector device by means of: a tilting movement of the reflector device using the movement device, and/or rotating the image displayed by the screen.

18. The display apparatus of claim 11, wherein the display apparatus further comprises:
a detection device that detects: an eye position of a user who is located in a situation for use of the display apparatus behind the display apparatus, and/or a distance between the reflector device and an object arranged in the situation for use in front of the display apparatus; and
a control apparatus configured to control the movement device to move the reflector device depending on the detected eye position of the user and/or the detected distance.

19. A motor vehicle, comprising the display apparatus of claim 11.

20. The motor vehicle of claim 19, wherein the display apparatus is arranged on the roof inner side in a rear of the motor vehicle.
